(19) United States
(12) Patent Application Publication
(10) Pub. No.: US 2026/0016614 A1
(43) Pub. Date: Jan. 15, 2026

(54) Optical Compensation Films Based on Stretched Cyclic Block Copolymers

(71) Applicant: Akron Polymer Systems, Inc., Akron, OH (US)

(72) Inventors: Limin Sun, Copley, OH (US); John Harvey, Seville, OH (US); Lang Hu, Tallmadge, OH (US)

(21) Appl. No.: 19/265,534

(22) Filed: Jul. 10, 2025

Related U.S. Application Data
(60) Provisional application No. 63/669,277, filed on Jul. 10, 2024.

(51) Int. Cl. G02B 1/04; C08J 5/18; G02B 5/30

(52) U.S. Cl. CPC G02B 1/04; C08J 5/18; G02B 5/3083; C08J 2353/02

(57) ABSTRACT

By stretching a semi-crystalline CBC film, an in-plane orientated compensation film could be obtained with good optical transparency and significantly higher retardation values at a much lower film thicknesses because of a relatively high amount of birefringence per unit thickness.

### CROSS REFERENCE TO RELATED APPLICATIONS

This application claims benefit to U.S. Provisional Application 63/669,277, Jul. 10, 2024, filed which is incorporated in its entirety.

### FIELD OF THE INVENTION

The invention relates to optical compensation films for use in devices such as liquid crystal displays (LCD), organic light emitting diode (OLED) displays, optical switches, and waveguides where the phase of light propagation is controlled. More particularly, the optical compensation films of the present invention are based on the in-plane orientation of semi-crystalline polymer films.

### BACKGROUND

In-plane oriented polymer films are commonly used as optical compensation films for flat panel displays. Examples of optical compensation films include uniaxially oriented films, such as “C− plate” films (where the refractive index of the film in three directions follows the relationship nx=ny>nz, where x and y represent the two in-plane directions and z represents the film thickness direction), “A+ plate” films (where nx>ny=nz), or biaxially oriented “B− plate” films (where nx>ny>nz), etc. In-plane oriented polymer films can be prepared by polymer solution casting, melt extrusion, or molding with or without further uniaxially or biaxially stretching.

An optical compensation film can have an out-of-plane retardation (Rth) and an in-plane retardation (Re), which are defined by the following equations:

$$Rth = [ nz - ( nx + ny ) / 2 ] \times d = Δ n \times d$$

$$Re = ( nx - ny ) \times d = Δ {n}_{‖} \times d$$

Here, d is the film thickness, Δn [symbol] is the out-plane birefringence, and Δn_{|} is the in-plane birefringence. In common flat panel displays, such as LCDs and OLEDs, the in-plane oriented optical compensation film usually has an out-of-plane retardation (Rth) from about −55 nm to about −550 nm and an in-plane retardation (Re) from about 50 nm to about 580 nm. Typically, the in-plane oriented optical compensation films have a thickness from 20 μm to 100 μm with a preference toward thinner films.

Nz, as defined in the following equation, is used to characterize the optical properties of biaxially oriented films:

$$Nz = ( nx - nz ) / ( nx - ny ) = 1 / 2 + Rth / Re$$

$$For an A + plate film ( where nx > ny = nz ) , Nz = 1 ;$$

$$For a B - plate film ( where nx > ny > nz ) , Nz > 1 ;$$

$$and for a C - plate film ( where nx = ny > nz ) , Nz is approaching + ∞$$

The refractive index of a material is wavelength dependent, and this dependency can be described with a two-coefficient Cauchy equation:

$$n ( λ ) = A + B / {λ}^{2}$$

Here, λ is the wavelength of light, while A and B are two independent constants. Based on this equation, the refractive index of an optical film increases with decreasing wavelength, and this relationship is called “normal dispersion”. Accordingly, the birefringence and retardation of the film will also exhibit normal dispersion. However, in display devices it is preferable for the retardation of a compensation film to stay the same or increase with wavelength across the whole visible range. When the retardation value increases with increasing wavelength it is called “reverse dispersion”. The dispersion curve of a compensation film may be measured by comparing of the retardation value at 550 nm (the middle point of the visible wavelength range, 400 nm to 700 nm) with the retardation value at 450 nm (shorter wavelength range) and 650 nm (longer wavelength range):
R450/R550 and R650/R550

When these ratios approach 1.0, the dispersion curve of a compensation film becomes flatter. When the value of R450/R550 is about 0.82, a compensation film exhibits “an ideal reverse dispersion”.

Although many kinds of polymers have been proposed and used to prepare in-plane oriented compensation films including polyesters (PETs), polyimides (PIs), polycarbonates (PCs), polyethersulfones (PESs), cellulose triacetates (TACs), cyclic olefin polymers (COPs), fully hydrogenated vinyl aromatic monomer-conjugated diene block copolymers (CBCs), etc., only TAC and COP films are currently used at large scale in the display industry for in-plane oriented compensation films. The reasons why TAC and COP films dominate the in-plane oriented compensation film market include their suitable retardation value at reasonable thicknesses, relatively flat dispersion, excellent optical transparency and lower cost.

Typically, a polarizer used in the display industry consists of a TAC/polyvinyl alcohol (PVA)/TAC sandwich structure. Plain TAC film is usually used to protect the PVA film because it has good adhesion with PVA film. Plain TAC film is made by solution casting and has very low birefringence. Modified TAC film may possess in-plane orientation, making it capable to both protect the PVA film and provide optical compensation. Such modified TAC films include N-TAC film made by the Konica-Minolta Corporation and B-TAC film made by the Fujifilm Corporation. Both films are widely used in vertical aligned LCDs (VA-LCD). However, TAC film has a high water absorption rate and a high photoelastic constant, making its optical properties relatively unstable. This instability is worse when the film is thinner which is needed to meet the trend of thinner and lighter display devices. Non-TAC films for polarizers are highly desirable.

COP resin is made by the polymerization of alicyclic monomers (typically, norbornene and/or its derivatives), and it exhibits both extremely low polarizability and high thermal stability. COP films used as polarizer protector film with in-plane orientation optical compensation for VA-LCDs have become more popular because of their low moisture absorption rate, flat dispersion curve, low photoelastic constant, and excellent optical transparency. Zeon Corporation's Zeonor brand COP compensation film is made by melt extrusion and stretching with a precise thickness, avoiding any volatile organic solvent in the process. However, COP film supply is dominated by Zeon and there are only a limited number of alternative suppliers.

CBC films have many of the same beneficial properties that COP films have, including excellent optical transparency, low moisture absorption rates, a flat dispersion curve, and low photoelastic constants, but have relatively low in-plane and out-of-plane birefringence without additional processing steps after initial solvent or melt film casting. This has made CBC films excellent candidates for application in in-plane switching LCDs (IPS LCD) where low-retardation is beneficial in the polarizer protection film. To take advantage of the beneficial properties of CBCs in optical compensation films requires additional processing steps to enhance the limited inherent birefringence to achieve sufficient retardance within an acceptable film thickness.

Much work has been done to demonstrate that film stretching can be used to increase the retardance of a polymer film sufficiently to be used as an optical compensation film. These efforts have required either complex stretching protocols (JP 2006-133720; WO 2009-084661; JP 2023-177264), complex stretching geometries (JP 2016-109931), or subsequent thermal treatments (WO 2017-002868), all of which would require either special equipment, additional process time and/or subsequent processing steps.

There is a strong interest to achieve a CBC optical compensation film with reduced thickness using simple processing steps. To achieve this, larger birefringence is needed. Polymer crystals can be more birefringent than an equivalent amount of amorphous polymer due to increased density and strong molecular chain orientation, while the geometric anisotropy of polymer crystals make them very responsive to orientation during stretching. Previous work focused on amorphous CBC resins because polymer crystals usually introduce haze in the film which reduces light transmission and increases light depolarization. More recently, new CBC resins (U.S. Pat. No. 10,450,455) have been developed. The films made from these resins can have a significant amount of crystallinity but still maintain a high level of optical transmission, which offers a new opportunity to use CBCs in commercially viable in-plane orientation optical compensation films.

### SUMMARY

In-plane oriented compensation films have been made by stretching semi-crystalline films from polymers consisting of a fully hydrogenated vinyl aromatic monomer-conjugated diene block copolymer (U.S. Pat. Nos. 6,632,890, 6,350,820), i.e., cyclic block copolymers (CBCs). One example of a semi-crystalline CBC polymer using styrene and butadiene monomers is shown below.

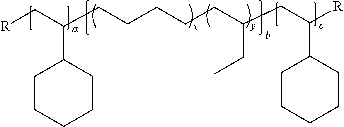

In-plane oriented semi-crystalline CBC polymer films may be a C− plate film having the refractive index profile of nx=ny>nz, a B− plate film having the refractive index profile of nx>ny>nz, or a A+ plate film having the refractive index profile of nx>ny=nz. In-plane oriented semi-crystalline CBC polymer films may be prepared by hot-press molding, melt extrusion or solution casting, followed by uniaxial or biaxial film stretching. The in-plane stretched semi-crystalline CBC film may have an out-of-plane retardation (Rth) from about −55 nm to about −550 nm and in-plane retardation (Re) from about 50 nm to about 580 nm, with the value of dispersion index of R450/R550 or R650/R550 in the range of 1.000±0.025.

### DETAILED DESCRIPTION

Similar to the COP materials, CBC materials have many attractive properties for optical applications such as excellent optical transparency, a high-glass-transition temperature (Tg), good moisture-barrier properties, and low density. CBCs have been proposed to be a candidate polymer for the films used in polarizers.

CBC films prepared by melt extrusion without any stretching demonstrated near-zero retardation (WO 2009/137278). Although the mechanical and birefringence behaviors of stretched CBC film were also investigated (Weijun Zhou, et al; SID Journal, 18/1, pp-66), no method has been found to manufacture thin in-plane oriented CBC compensation films using conventional processing techniques.

An optical film with an Nz coefficient close to 1.0 (A+ plate) was prepared by a fixed-end uniaxial stretching method on an amorphous thermoplastic CBC film (JP2023-177264). Stretching elongations between 210% to 500% only achieved a Re around ˜100-150 nm and a Rth around ˜50-85 nm with thicknesses ranging around 40-85 μm. These resultant compensation films have relatively low retardance and need to be relatively thick to achieve the performance necessary for commercial optical compensation films. High elongations were need to achieve the minimal amount of birefringence per unit thickness, and neither a C− plate (Nz is approaching+∞) nor a B− plate (Nz>1) were studied in this work.

It was unexpectedly determined that by stretching a semi-crystalline CBC film, an in-plane orientated compensation film could be obtained with good optical transparency and significantly higher retardation values at a much lower film thicknesses because of a relatively high amount of birefringence per unit thickness.

The CBC polymers used to make the films can consist of fully hydrogenated styrene-conjugated diene block copolymers. Typical vinyl aromatic monomers include, but are not limited to, styrene, alpha-methylstyrene, all isomers of vinyl toluene, all isomers of ethyl styrene, propyl styrene, butyl styrene, vinyl biphenyl, vinyl naphthalene, vinyl anthracene and the like, and mixtures thereof. Preferably, the vinyl aromatic monomer is styrene or alpha-methylstyrene. The conjugated diene monomer can be any monomer having two conjugated double bonds. Such monomers may include, but are not limited to, 1, 3-butadiene, 2-methyl-1, 3-butadiene (isoprene), 2-methyl-1, 3 pentadiene, as well as similar compounds, and mixtures thereof. Preferably, the conjugated diene monomer is butadiene or isoprene.

The CBC polymer may be comprised of at least two blocks of hydrogenated vinyl aromatic monomers, and at least one block of hydrogenated conjugated diene.

The CBC polymer may consist of at least one tapered block and/or random copolymerized block in the hydrogenated vinyl aromatic block and/or the hydrogenated conjugated diene block;

The CBC polymer resin may be comprised of another hydrogenated block copolymer such as a hydrogenated diblock copolymer, a hydrogenated pentablock copolymer or a hydrogenated radial copolymer.

The CBC polymers may have a weight ratio of the hydrogenated conjugated dienes polymer block to hydrogenated vinyl aromatic polymer block of 40:60 or less.

The CBC polymers may have a molecular weight from 30,000 to 200,000.

The CBC films may be prepared by hot press molding, melt extrusion, or solution casting.

The CBC films before stretching may have a crystallinity greater than or equal to 1%.

The un-stretched CBC film may have thickness from 50 μm to 300 μm.

The film stretching ratio (L/L₀; where L is the length of the film in the stretching direction after stretching and Lo is the length of the film in the stretching direction before stretching) can vary from 110% to 250% in the MD (machine direction) and TD (direction perpendicular to MD) directions, independently (uniaxially), or in combination (biaxially).

The stretched CBC film may have thickness from 20 μm to 200 μm.

The in-plane orientated optical compensation film by stretching the CBC film may have an out-of-plane retardation (Rth) from about −55 nm to about −550 nm and in-plane retardation (Re) from about 50 nm to about 580 nm.

The in-plane orientated optical compensation film by stretching the CBC film may have a dispersion index value for R450/R550 or R650/R550 in the range of 1.000±0.025.

Unless otherwise defined, all technical and scientific terms used herein have the same meaning as commonly understood by one of ordinary skill in the art to which this invention pertains. In case of conflict, the present specification, including definitions, will control.

Unless otherwise specified, “a,” “an,” “the,” “one or more of,” and “at least one” are used interchangeably. The singular forms “a”, “an,” and “the” are inclusive of their plural forms.

The recitations of numerical ranges by endpoints include all numbers subsumed within that range (e.g., 0.5 to 5 includes 1, 1.5, 2, 2.75, 3, 3.80, 4, 5, etc.).

The term “about,” when referring to a value or to an amount of mass, weight, time, volume, concentration, or percentage is meant to encompass variations of ±1% from the specified amount. The terms “comprising” and “including” are intended to be equivalent and open-ended. The phrase “consisting essentially of” means that the composition or method may include additional ingredients and/or steps, but only if the additional ingredients and/or steps do not materially alter the basic and novel characteristics of the claimed composition or method. The phrase “selected from the group consisting of” is meant to include mixtures of the listed group.

Moreover, the present disclosure also contemplates that in some aspects, any feature or combination of features set forth herein can be excluded or omitted. To illustrate, if the specification states that a complex comprises components A, B and C, it is specifically intended that any of A, B or C, or a combination thereof, can be omitted and disclaimed singularly or in any combination.

Weight percent: All weight (and mass) percents expressed herein (unless otherwise indicated) are based on overall composition weight.

### EXPERIMENTAL

CBC resin samples were obtained from USI Corporation: ViviOn 1325 (MFR=13 g/10 minutes, 2.16 kg at 260° C.), and ViviOn 0510 (MFR=5 g/10 minutes, 2.16 kg at 260° C.).

Hydrogenated polystyrene (H-PS, crystallinity) was purchased from Sigma Aldrich and used as a comparison resin.

CBC film made from Vivion 0510 HFE resin (MFR=2.5 g/10 minutes, 2.16 kg at 230° C.) was obtained from USI Corporation (thickness: 105 μm).

Commercial grade COP film (Zeonor ZB12) with a thickness of 52 μm was used as a comparison film.

The solution cast films were made by dissolving the polymer in cyclohexane and casting the polymer solution on glass. The cast solution was allowed to dry at room temperature and subsequently placed in a vacuum oven at room temperature for 8 hours.

The hot-press molded film was made by pressing the polymer resin between two glass plates at an elevated temperature for 3 minutes.

The amount of the hydrogenated vinyl aromatic polymer block in the copolymer was measured by proton NMR using a Bruker Ascend III 500 MHz NMR instrument equipped with a prodigy probe in cyclohexane-d.

The intrinsic viscosity (IV) of CBC resins were measured by a Cannon® auto capillary viscometer using cyclohexane and the solvent was at 30° C.

Thermal gravity analysis of CBC resins was conducted by a TGA5500 (TA Instruments, Inc.) under nitrogen flow and the temperature where the sample weight loss reached 5% (T5%) as well as decomposition onset temperature (Td) were measured. The scan rate was 10° C./min.

The glass-transition temperature (Tg) for the rigid phase (i.e., hydrogenated styrene phase) and the crystal melt temperature (Tm) for the flexible phase (i.e., hydrogenated butadiene phase) of each CBC material was determined by differential scanning calorimetry (DSC Q200, TA Instruments, Inc.). The scan rate was 10° C./min and the Tg was determined from the second heating scan curve. The weight percentage of the crystallinity of each sample was calculated by the following equation:

$$X percentage = ( {H}_{f} / 292 ) \times 100 \%$$

Here X % is the weight percentage of the crystallinity; the heat of fusion H_{f} is the heat of fusion of the melting crystals; 100% crystalline polyethylene has an art-recognized H_{f} of 292 J/g (US 2001-0038045).

Uniaxial stretching of CBC films made by hot press molding was performed with in-house developed equipment and a heating chamber. The film was pre-heated for 3 minutes to reach the desired stretching temperature and subsequently stretched at a rate of ˜1%/sec to a selected stretch ratio. The transverse direction (Td) was either constrained or unconstrained.

Biaxial stretching of CBC films made by melt extrusion was performed with a Brukner KARO IV stretching machine equipped with a heating chamber. The film was pre-heated for a certain time to a desired stretching temperature and subsequently stretched at ˜1%/sec to a selected stretch ratio. The stretching ratio in both directions [machine direction (MD) and transverse direction (TD)] were varied independently to get the desired combination of refractive indices nx, ny, and nz.

The out-plane birefringence (Δn [symbol] ) and average refractive index [nₐᵥₑ=(nx²+ny²+nz²)^{1/2}] of the CBC films were measured by a Metricon Model 2010/M Prism Coupler using single film mode at a wavelength of 633 nm.

The retardation values of the CBC films were measured by a VASE® Ellipsometer (J. A. Woollam Co., Inc.).

The optical transparency of the CBC films including b*, haze, Yₜₒₜₐₗ were measured with a HunterLab UltraScan VIS spectrophotometer.

### EXAMPLES AND RESULTS

### Example 1. CBC Characterization

Both CBC polymer samples possess highly hydrogenated, vinyl aromatic polymer blocks (i.e. hydrogenated styrene (H-PS)) content, as determined by ¹H NMR). Before dissolution and casting the crystallinity of the ViviOn 1325 and ViviOn 0515 beads were determined. The ViviOn 1325 had <1% crystallinity as received and ViviOn 0510 had >2% crystallinity as received. Both grades were dissolved in cyclohexane and cast onto glass to form a uniform film for further characterization. Although ViviOn 0510 has a higher H-PS content, its Tg and IV are lower than ViviOn 1325, as shown in Table 1, which may be due to the different block and micro-phase structure of the polymers. For comparison, COP has a higher refractive index than CBC and zero crystallinity.

TABLE 1
CBC Resin Characterization

| | | | H-NMR | | | | | | | |
|---|---|---|---|---|---|---|---|---|---|---|
| | | | H-PS | IV | Metricon | TGA | | DSC | | |
| Polymer information | | | ratio | dL/ | Refractive | T5% | Td | Tm | Tg | |
| Polymer | Grade | Remark | (wt %) | g | index | (° C.) | (° C.) | (° C.) | (° C.) | X % |
| H-PS | Sigma | Powder | 100 | 0.15 | 1.507 | 343 | 356 | — | 143 | 0 |
| CBC | 1325 | bead | 87 | 0.44 | 1.509 | 406 | 409 | 68 | 127 | 0.7 |
| CBC | 0510 | bead | 91 | 0.36 | 1.511 | 408 | 415 | 77 | 117 | 2.1 |
| CBC | 0510 | film | — | — | 1.5094 | 358 | 363 | 78 | 121 | 5.7 |
| | HFE | | | | | | | | | |
| COP | ZB12 | film | 0 | — | 1.534 | 393 | 341 | — | 124 | 0 |

### Example 2. Transparency and Birefringence of CBC Films Before Stretching

CBC films were prepared by hot-press molding. The films, despite having measurable increases in the amounts of crystallinity, had good transparency and low haze. Both Vivion 0510 films and ViviOn 1325 films prepared by hot-press molding exhibited very low birefringence, though Vivion 0510 films had about twice the crystallinity than the ViviOn1325 films and both grades of ViviOn had significantly higher crystallinity after thermal processing than as received.

TABLE 2
CBC Films Before Stretching

| | Hot | | | | | | | | |
|---|---|---|---|---|---|---|---|---|---|
| | press | | | | | | | | |
| | Temp | Film | Hunterlab | | | Metricon | | DSC | d |
| Polymer | (° C.) | size | b* | Haze | Ytotal | Δn | n | X % | (μm) |
| CBC 1325 | 216 | 2 inch | 0.33 | 2.60 | 91.6 | −0.0001 | 1.5070 | — | 260 |
| CBC 1325 | 216 | 2 inch | 0.32 | 0.48 | 92.1 | 0.0000 | 1.5069 | — | 210 |
| CBC 1325 | 216 | 4 inch | 0.36 | 3.91 | 92.0 | −0.0001 | 1.5067 | 2.2 | 200 |
| CBC 0510 | 204 | 2 inch | 0.29 | 0.69 | 92.1 | −0.0002 | 1.5064 | 5.0 | 220 |
| CBC 0510 | 216 | 5 inch | 0.33 | 3.57 | 92.0 | −0.0003 | 1.5062 | 4.8 | 150 |
| CBC 0510 | 232 | 3 inch | 0.29 | 0.56 | 92.1 | −0.0003 | 1.5061 | 4.5 | 200 |
| CBC-0510 | — | A4 | 0.19 | 0.06 | 92.0 | −0.0007 | 1.5094 | 5.7 | 106 |
| HFE | | | | | | | | | |
| COP-ZB12 | — | A4 | 0.30 | 1.07 | 91.1 | −0.0015 | 1.5338 | 0 | 52 |

The optical properties of the Vivion 0510 HFE CBC film are also listed in Table 2. This grade had even higher levels of crystallinity, higher birefringence and a higher refractive index but maintained high optical clarity.

Compared to CBC-0510 HFE based films, COP has a higher refractive index, higher birefringence and higher haze level despite being half the thickness.

### Example 3. Retardation and Dispersion of CBC Films

Without stretching, the ViviOn 0510 films and the ViviOn1325 films made by hot-press molding demonstrate C− plate film (nx=ny>nz) behavior with very flat dispersion but would have to be very thick to be used as an optical compensation film in a display, as shown in Table 3. The Re values of all these sample films were minimal. As for Rth/d values, ViviOn 1325 films were smaller than the ViviOn 0510 films, demonstrating the potential to make a thinner compensation film with the higher crystallinity ViviOn 0510 films. The CBC-0510 HFE based film showed the largest un-stretched retardation values both in-plane and out-of-plane, maybe due to the higher amount of crystallinity in the film and the stretching that occurs during melt extrusion.

TABLE 3
Optical Properties of CBC Films

| Film information | | | | | | | | | |
|---|---|---|---|---|---|---|---|---|---|
| | Hot | Ellipsometry | | | | | | | |
| | press | | | Re450/ | Re650/ | Rth450/ | Rth650/ | Rth/ | d |
| Polymer | Temp(° C.) | Re550 | Rth550 | Re550 | Re550 | Rth550 | Rth550 | d | (μm) |
| CBC 1325 | 216 | 0.1 | −58.0 | 0.987 | 1.051 | 1.003 | 0.998 | −0.22 | 260 |
| CBC 1325 | 216 | 0.1 | −46.4 | 0.794 | 1.205 | 1.003 | 0.998 | −0.22 | 210 |
| CBC 1325 | 216 | 5.0 | −10.8 | 0.995 | 1.003 | 0.989 | 1.001 | −0.05 | 200 |
| CBC 0510 | 204 | 18.8 | −151.6 | 1.001 | 1.000 | 1.003 | 0.999 | −0.69 | 220 |
| CBC 0510 | 216 | 5.4 | −103.1 | 0.993 | 1.005 | 1.003 | 0.998 | −0.69 | 150 |
| CBC 0510 | 232 | 1.3 | −136.4 | 0.977 | 1.020 | 1.016 | 0.988 | −0.68 | 200 |
| CBC- | — | 63 | 104 | 0.999 | 1.001 | 1.005 | 0.997 | −0.98 | 106 |
| 0510 HFE | | | | | | | | | |

### Example 4. Uniaxially Stretched Hot-Press Molded CBC Film

Hot-press molded CBC films were uniaxially stretched at 150° C. with different stretch ratios (L/L₀). The stretched films exhibited good optical clarity and A+ plate film performance (nx>ny=nz, Rth=Re/2) with very flat dispersion. The semi-crystalline CBCs exhibited higher Re/ds and Rth/ds at lower draw ratios than previously exhibited by amorphous CBCs enabling them to be thinner optical compensation films. To make a quarter wave plate (QWP) A+ compensation film (Re=137.5 nm, Rth=Re/2), ViviOn 0510, with a higher level of crystallinity, can be a thinner film than the less crystalline ViviOn 1325 films.

TABLE 4
Optical Properties of Uniaxially Stretched CBC Films

| | Stretcher | | Ellipsometry | | | | | | | | | | d for |
|---|---|---|---|---|---|---|---|---|---|---|---|---|---|
| Film | ST | Ratio | Re550 | Rth550 | Re450/ | Re650/ | Rth450/ | Rth650/ | | d | Re/ | Rth/ | QWP |
| Polymer | (° C.) | L/L₀ | (nm) | (nm) | Re550 | Re550 | Rth550 | Rth550 | Nz | (μm) | d | d | (μm) |
| CBC- | 150 | 1.00 | 5.0 | −10.8 | 0.995 | 1.003 | 0.989 | 1.001 | 2.66 | 200 | 0.03 | −0.05 | — |
| 1325 | | 1.25 | 455 | −238 | 1.007 | 0.996 | 1.010 | 1.001 | 1.02 | 200 | 2.28 | −1.19 | 60 |
| | | 1.50 | 376 | −198 | 1.010 | 0.995 | 1.016 | 0.985 | 1.03 | 132 | 2.85 | −1.50 | 48 |
| | | 1.75 | 382 | −202 | 1.011 | 0.994 | 1.003 | 0.992 | 1.03 | 120 | 3.18 | −1.68 | 43 |
| | | 2.00 | 420 | −218 | 1.012 | 0.993 | 1.005 | 0.991 | 1.02 | 124 | 3.39 | −1.76 | 41 |
| CBC- | 150 | 1.00 | 5.4 | −103 | 0.993 | 1.005 | 1.003 | 0.998 | 20 | 150 | 0.04 | −0.69 | — |
| 0510 | | 1.25 | 995 | −525 | 1.001 | 0.999 | 1.004 | 0.999 | 1.03 | 200 | 4.98 | −2.63 | 28 |
| | | 1.50 | 665 | −378 | 1.002 | 0.998 | 1.013 | 0.988 | 1.07 | 116 | 5.73 | −3.26 | 24 |
| | | 1.75 | 792 | −370 | 1.003 | 0.998 | 1.025 | 0.984 | 0.97 | 136 | 5.82 | −2.72 | 24 |
| | | 2.00 | 495 | −201 | 1.003 | 0.998 | 1.001 | 0.996 | 0.91 | 81 | 6.11 | −2.48 | 23 |

### Example 5: Biaxially Stretched CBC Films

CBC film was made by melt extrusion using Vivion 0510 HFE. The film thickness was 106 um and had a crystallinity of 5.7%, which is higher than that of ViviOn 0510 and ViviOn 1325 before stretching.

The CBC films were pre-heated at 130° C. for 90 seconds then stretched at a 1%/second strain rate to different MD and TD stretch ratios. The optical performance of the resultant stretched films are shown in Table 5.

All films maintained high optical clarity after stretching. When the films were uniaxially stretched, no matter the stretching ratio (MD changed from 1.5, to 2.0, and 3.0 in samples No. 1, No.2 and No. 3 of Table 5), the Nz values of the films were close to 1.0 with an ideal A+ plate performance. Additionally, the Re per thickness and Rth per thickness were higher than those exhibited by amorphous CBCs at similar or higher draw ratios. The semi-crystalline CBCs can be used to achieve the retardance necessary for optical compensation films at lower thicknesses with simple stretching techniques.

When the MD stretching ratio is fixed at 1.5 (samples No. 4 to No. 8), the Nz values of the films increased with increasing TD stretching ratio, from 1.19 (A+ plate), to 2.98 (B− plate) and then 41.7 (C− plate).

When the MD and TD stretching ratios are the same but increasing (sample No. 9 to 11), the Nz values of the films were around 2 to 4, which are B-plate-like, but with lower retardation values.

TABLE 5
Optical Properties of Biaxial Stretched CBC Films

| | | | | d, | | | Re550, | Rth550, | Re450/ | Re650/ | Rth450/ | Rth650/ | Re/ | Rth/ | |
|---|---|---|---|---|---|---|---|---|---|---|---|---|---|---|---|
| | ID | MD | TD | um | b* | Haze | nm | nm | 550 | 550 | 550 | 550 | d | d | Nz |
| CBC | 1 | 1.5 | free | 81.5 | 0.17 | 0.33 | 372.0 | −199.7 | 1.001 | 1.000 | 1.008 | 0.996 | 4.56 | −2.45 | 1.04 |
| 0510 | 2 | 2.0 | free | 67.0 | 0.16 | 0.24 | 322.1 | −170.7 | 1.001 | 1.000 | 1.008 | 0.996 | 4.81 | −2.55 | 1.03 |
| HFE | 3 | 3.0 | free | 49.0 | 0.17 | 0.37 | 242.2 | −121.8 | 1.001 | 1.000 | 1.007 | 0.998 | 4.94 | −2.49 | 1.00 |
| | 4 | 1.5 | 1.0 | 78.0 | 0.17 | 0.45 | 261.3 | −180.4 | 1.000 | 1.000 | 1.008 | 0.996 | 3.35 | −2.31 | 1.19 |
| | 5 | 1.5 | 1.2 | 62.0 | 0.17 | 0.51 | 161.1 | −153.7 | 1.000 | 1.000 | 1.007 | 0.996 | 2.60 | −2.48 | 1.45 |
| | 6 | 1.5 | 1.3 | 61.0 | 0.16 | 0.80 | 95.7 | −139.4 | 0.999 | 1.000 | 1.008 | 0.996 | 1.57 | −2.29 | 1.96 |
| | 7 | 1.5 | 1.4 | 58.0 | 0.15 | 0.34 | 53.9 | −133.4 | 0.999 | 1.000 | 1.005 | 0.998 | 0.93 | −2.30 | 2.98 |
| | 8 | 1.5 | 1.5 | 54.5 | 0.15 | 0.43 | 3.2 | −131.9 | 0.998 | 1.000 | 1.004 | 0.998 | 0.06 | −2.42 | 41.70 |
| | 9 | 1.6 | 1.6 | 45.5 | 0.15 | 0.16 | 76.5 | −109.6 | 1.000 | 1.000 | 1.006 | 0.999 | 1.68 | −2.41 | 1.93 |
| | 10 | 1.8 | 1.8 | 37.5 | 0.15 | 0.21 | 47.3 | −88.2 | 0.999 | 1.000 | 1.005 | 0.999 | 1.26 | −2.35 | 2.37 |
| | 11 | 2.0 | 2.0 | 34.0 | 0.14 | 0.14 | 25.5 | −83.5 | 0.999 | 1.000 | 1.003 | 0.999 | 0.75 | −2.46 | 3.77 |

| | | | | | | | | | | | | | | |
|---|---|---|---|---|---|---|---|---|---|---|---|---|---|---|
| COP ZB12 | — | — | 52 | 0.30 | 1.07 | 54.2 | −137 | 1.008 | 0.995 | 1.026 | 0.992 | 1.04 | −2.63 | 3.03 |

The complete disclosure of all patents, patent applications, and publications, and electronically available material cited herein are incorporated by reference. The foregoing detailed description and examples have been given for clarity of understanding only. No unnecessary limitations are to be understood therefrom. The invention is not limited to the exact details shown and described, for variations obvious to one skilled in the art will be included within the invention defined by the claims.

1. An in-plane oriented optical compensation film with an out-of-plane retardation (Rth) from −55 nm to −550 nm and in-plane retardation (Re) from 50 nm to 580 nm with a thickness from 20 μm to 200 μm, preferably, from 20 μm to 40 μm prepared by uniaxial or biaxial stretching of a semi-crystalline cyclic block copolymer (CBC) film where the crystallinity before stretching is between 1% and 10%.

2. The film of claim 1 wherein the in-plane oriented polymer film may be used as a C−plate film having the refractive index profile of nx≈ny (i.e. |Re|≤10 nm)>nz and Nz>20

3. The film of claim 1 wherein the in-plane oriented polymer film may be used as a B−plate film having the refractive index profile of nx>ny>nz and Nz>1.

4. The film of claim 1 wherein the in-plane oriented polymer film may be used as an A+plate film having the refractive index profile of nx>ny≈nz (i.e. |(ny−nz)×d|≤10 nm) and Nz=1±0.1.

4. The film of claim 1 wherein the in-plane oriented optical compensation film has a dispersion index of R450/R550 or R650/R550 in the range of 1.000±0.025.

5. The film of claim 1 wherein the un-stretched CBC polymer film is prepared by hot-press molding, melt extrusion, or solution casting

6. The film of claim 1 wherein the un-stretched CBC film has a thickness from 50 μm to 300 μm, preferably, from 50 μm to 100 μm.

7. The film of claim 1 wherein the stretching temperature is from 100° C. to 200° C., preferably, from 130° to 170° C.

8. The film of claim 1 wherein the un-stretched film was stretched at a stretching ratio of 110% to 300%, either uniaxially or in a combination of MD and TD directions biaxially.

9. The film of claim 1 wherein the CBC polymer comprises at least two blocks of hydrogenated vinyl aromatic polymers, and at least one block of hydrogenated conjugated diene.

10. The film of claim 9 wherein the CBC polymer has a hydrogenated conjugated dienes polymer block to hydrogenated vinyl aromatic polymer block weight ratio of 40:60 or less.

11. The film of claim 10 wherein the CBC polymer comprises at least one tapered block and/or random copolymerized block in the hydrogenated vinyl aromatic polymer block and/or the hydrogenated conjugated diene polymer block.

12. The film of claim 9 wherein the CBC polymer is comprised another hydrogenated block copolymer which is either a hydrogenated diblock copolymer, a hydrogenated pentablock copolymer or a hydrogenated radial copolymer.

13. The film of claim 9 wherein the CBC polymer consists of a fully hydrogenated styrene-conjugated diene block copolymer where the vinyl aromatic monomers are any one of styrene, alpha-methylstyrene, any isomer of vinyl toluene, any isomer of ethyl styrene, propyl styrene, butyl styrene, vinyl biphenyl, vinyl naphthalene, vinyl anthracene, or mixtures thereof.

14. The film of claim 9 wherein the CBC polymer consists of a fully hydrogenated styrene-conjugated diene block copolymer where the conjugated diene monomers are any one of 1, 3-butadiene, 2-methyl-1, 3-butadiene (isoprene), 2-methyl-1, 3 pentadiene, or mixtures thereof.

15. The film of claim 1 wherein the CBC polymer has a molecular weight from 30,000 to 200,000.
